(19) United States
(12) Patent Application Publication
(10) Pub. No.: US 2013/0209803 A1
(43) Pub. Date: Aug. 15, 2013

(54) CROSSLINKED RUBBER, RUBBER-SHEATHED CABLE USING SAME, AND CROSSLINKED RUBBER PRODUCING METHOD

(71) Applicant: Hitachi Cable, Ltd., (US)

(72) Inventors: Takashi Aoyama, Hitachi (JP); Tomiya Abe, Hitachi (JP); Kiyoshi Watanabe, Hitachi (JP); Shingo Ashihara, Mito (JP); Dai Ishikawa, Tsukuba (JP); Shuhei Yasuda, Hitachi (JP)

(73) Assignee: Hitachi Cable, Ltd., Tokyo (JP)

(21) Appl. No.: 13/762,315

(22) Filed: Feb. 7, 2013

(30) Foreign Application Priority Data
Feb. 15, 2012 (JP) 2012-030681

(51) Int. Cl. C09D 111/00; C09D 119/00

(52) U.S. Cl. CPC C09D 111/00; C09D 119/00
USPC 428/375; 524/576; 524/567

(57) ABSTRACT

A crosslinked rubber is composed of rubber molecules, which, before crosslinking, contain hot dissociatable and cold associatable crosslinking groups to dissociate from each other in a hot state and associate together in a cold state, and silane crosslinking groups, and which, after molding, are silane-crosslinked together by a silanol condensation reaction of the silane crosslinking groups together with moisture, with the hot dissociatable and cold associatable crosslinking groups associated together.

The present application is based on Japanese patent application No.2012-030681 filed on Feb. 15, 2012, the entire contents of which are incorporated herein by reference.

### BACKGROUND OF THE INVENTION

1. Field of the Invention

This invention relates to a crosslinked rubber, a rubber-sheathed cable using the same, and a crosslinked rubber producing method.

2. Description of the Related Art

Conventionally, crosslinked rubber has been widely used as materials for electric wires and cables. For example, ethylene-propylene rubber (EP rubber) has been widely used as an insulation for cables requiring heat resistance, cold resistance, insulation properties and the like. Also, chloroprene rubber (CR rubber) has been used as a sheath for cables requiring oil resistance, abrasion resistance, weather resistance and the like. These rubber materials are crosslinked with peroxide, sulfur, metal oxide or the like. For crosslinking, any method therefor requires heating treatment. Typically, in the case of rubber-sheathed cables, after extrusion coating by an extruder, rubber is crosslinked at a temperature of 100 degrees Celsius or higher using high temperature and high pressure steam and a high temperature molten metal salt.

However, there are such problems that the crosslinking by heating uses much heat energy, and heating equipment is costly. Accordingly, a method has been suggested that crosslinks the rubber-sheathed cables at ordinary temperature (100 degrees Celsius or lower) and ordinary pressure. That is, the method has been suggested that crosslinks the rubber-sheathed cables by using a free radical generating agent, grafting a silane compound on an EP rubber to make a silane grafted EP rubber, which is subsequently extrusion coated in the presence of a silanol condensation catalyst, and brought into contact with moisture. (Refer to JP-A-8-20703, and JP-A-2010-265349, for example.)

Also, a method has been suggested that crosslinks the rubber-sheathed cables by kneading a CR rubber and an organic silane compound having an amino group or mercapto group to make a silane grafted CR rubber, which is extrusion coated together with a masterbatch of a silanol condensation catalyst added to a CR rubber, and immersed in water at room temperature for one day. Refer to e.g. JP-A-64-1501.

These methods are called silane crosslinking, and make a large amount of energy and an expensive crosslinking apparatus unnecessary because leaving the rubber-sheathed cables unattended at ordinary temperature allows crosslinking to occur due to moisture in air. In order for the silane crosslinking to occur, however, particularly when leaving the rubber-sheathed cables unattended at ordinary temperature, it is necessary to leave them unattended for several days due to slow crosslinking. After extrusion, the rubber-sheathed cables are reeled around a drum. At the time of the drum reeling, if the rubber crosslinking does not proceed, the sheath rubber deforms due to drum reeling tension and cables' own weight. In the case of the rubber-sheathed cables to be crosslinked by high temperature and high pressure steam heating, after extrusion, heating equipment is installed before the drum reeling so that the rubber-sheathed cables are crosslinked at the time of the drum reeling. But due to the time-consuming silane crosslinking, the rubber-sheathed cables remain uncrosslinked and are reeled around the drum. Consequently, a flattening problem arises.

Refer to e.g. JP-A-8-20703, JP-A-2010-265349 and JP-A-64-1501.

SUMMARY OF THE INVENTION

Accordingly, it is an object of the present invention to provide a crosslinked rubber, which is less flattened by drum reeling, a rubber-sheathed cable using that crosslinked rubber, and a crosslinked rubber producing method, which does not require a large amount of energy and an expensive crosslinking apparatus, but whereby the crosslinked rubber is less flattened by drum reeling.

As a result of earnest study to achieve the above object, the inventors have completed the invention by finding out that no large amount of energy and expensive crosslinking apparatus are required by, before crosslinking, introducing into rubber molecules hot dissociatable and cold associatable crosslinking groups (i.e. thermo-reversible bonding crosslinking groups) to be dissociated from each other in a hot state and associated together by cooling, so that the hot dissociatable and cold associatable crosslinking groups dissociate from each other at a rubber extrusion temperature, and after extrusion, are passed through a water tank or the like and thereby immediately associate together, therefore allowing no flattening during drum reeling, and thereafter there occurs a silanol condensation reaction of silane crosslinking groups with moisture in air and the like, so that irreversible silane crosslinking proceeds without dissociation due to heat and the like. That is, the invention provides a below described crosslinked rubber, a rubber-sheathed cable using the same, and a crosslinked rubber producing method.

(1) According to a first feature of the invention, a crosslinked rubber comprises:

rubber molecules, which, before crosslinking, contain hot dissociatable and cold associatable crosslinking groups to dissociate from each other in a hot state and associate together in a cold state, and silane crosslinking groups, and which, after molding, are silane-crosslinked together by a silanol condensation reaction of the silane crosslinking groups together with moisture, with the hot dissociatable and cold associatable crosslinking groups associated together.

In the first feature, the following modifications and changes can be made.

The hot dissociatable and cold associatable crosslinking groups may be hydrogen bonding groups, ionic bonding groups, or dynamic covalent bonding groups.

(2) According to a second feature of the invention, a rubber-sheathed cable uses the crosslinked rubber specified in (1) above.

(3) According to a third feature of the invention, a crosslinked rubber producing method comprises:

before crosslinking, introducing hot dissociatable and cold associatable crosslinking groups into rubber molecules, the hot dissociatable and cold associatable crosslinking groups being dissociated from each other in a hot state and associated together in a cold state;

introducing silane crosslinking groups into the rubber molecules with the hot dissociatable and cold associatable crosslinking groups introduced therein;

molding the rubber molecules with the hot dissociatable and cold associatable crosslinking groups and the silane crosslinking groups introduced therein; and

silane-crosslinking the rubber molecules together by a silanol condensation reaction of the silane crosslinking groups together with moisture, with the hot dissociatable and cold associatable crosslinking groups associated together.

In the third feature, the following modifications and changes can be made.

The hot dissociatable and cold associatable crosslinking groups may be hydrogen bonding groups, ionic bonding groups, or dynamic covalent bonding groups.

### Points of the Invention

According to the invention, it is possible to provide the crosslinked rubber, which is less flattened by drum reeling, the rubber-sheathed cable using that crosslinked rubber, and the crosslinked rubber producing method, which does not require a large amount of energy and an expensive crosslinking apparatus, but whereby the crosslinked rubber is less flattened by drum reeling.

### BRIEF DESCRIPTION OF THE DRAWINGS

The preferred embodiments according to the invention will be explained below referring to the drawings, wherein:

FIG. 1 is an explanatory diagram showing a configuration of an extrusion line used in an embodiment according to the invention; and

FIG. 2 is a cross sectional view showing evaluation of flattening (ellipticity) of a cross sectional shape of a rubber-sheathed cable.

### DETAILED DESCRIPTION OF THE PREFERRED EMBODIMENT

### Summary of the Embodiment

In a crosslinked rubber and a rubber-sheathed cable using that crosslinked rubber in this embodiment, the crosslinked rubber comprises rubber molecules, which, before crosslinking, contain silane crosslinking groups, and hot dissociatable and cold associatable crosslinking groups to dissociate from each other in a hot state and associate together in a cold state, and which, after molding, are silane-crosslinked together by a silanol condensation reaction of the silane crosslinking groups together with moisture, with the hot dissociatable and cold associatable crosslinking groups associated together.

### Embodiment

A crosslinked rubber producing method in this embodiment includes: before crosslinking, introducing into rubber molecules silane crosslinking groups and hot dissociatable and cold associatable crosslinking groups to dissociate from each other in a hot state and associate together in a cold state; molding the rubber molecules with the hot dissociatable and cold associatable crosslinking groups and the silane crosslinking groups introduced therein; and silane-crosslinking the rubber molecules together by a silanol condensation reaction of the silane crosslinking groups together with moisture, with the hot dissociatable and cold associatable crosslinking groups associated together.

### Crosslinked Rubber

The crosslinked rubber in this embodiment comprises rubber molecules, which, before crosslinking, contain hot dissociatable and cold associatable crosslinking groups to dissociate from each other in a hot state and associate together in a cold state, and silane crosslinking groups, and which, after molding, are silane crosslinked together by a silanol condensation reaction of the silane crosslinking groups together with moisture, with the hot dissociatable and cold associatable crosslinking groups associated together. Each constituent element is described below.

### Rubber Molecules

As the rubber molecules used in this embodiment, there can be listed, for example EP rubber, CR rubber, natural rubber, acryl rubber, butyl rubber, silicon rubber, fluorine-containing rubber, acrylonitrile-butadiene rubber, styrene-butadiene rubber, chlorinated polyethylene and the like, but the rubber molecules are not particularly limited thereto.

### Hot Dissociatable and Cold Associatable Crosslinking Groups to Dissociate from Each Other in a Hot State and Associate Together in a Cold State

As the hot dissociatable and cold associatable crosslinking groups to dissociate from each other in a hot state and associate together in a cold state used in this embodiment, there can, as preferred examples, be listed hydrogen bonding groups or ionic bonding groups, or dynamic covalent bonding groups and the like, but the hot dissociatable and cold associatable crosslinking groups are not particularly limited thereto.

As the hydrogen bonding groups, there can be listed, for example hydroxyl groups (—OH), carboxyl groups (—COOH), amino groups (—NH₂) (—NHR) (—NR₂), amide groups (—NH—CO—), composite functional groups thereof and the like, but the hydrogen bonding groups are not particularly limited thereto.

As the ionic bonding groups, there are considered, for example metal salts of carboxylic acid, sulfonic acid, acrylic acid, methacrylic acid or the like. As metals for producing the metal salts, there can be listed, for example sodium, zinc, magnesium, potassium, calcium, lithium, beryllium and the like, but the metals for producing the metal salts are not particularly limited thereto.

As the dynamic covalent bonding groups, there can be listed, for example combinations of aldehyde groups and hydrazide groups and the like, but the dynamic covalent bonding groups are not particularly limited thereto. The aldehyde groups and the hydrazide groups react to produce an alkoxyamine and bond (crosslink) together. Besides, there can be listed combinations of tricyanoethylenecarboxylate groups and fulvene groups, which bond together by Diels-Alder reactions, combinations of carbon radical groups and nitroxide radical groups and the like, which form an alkoxyamine. Sulfide radical groups are also the dynamic covalent bonding groups. The sulfide radical groups bond together to form a disulfide.

Incidentally, in this embodiment, the term “dissociate from each other in a hot state” means that, for example, hydrogen bonds of —OH groups of glucosamines dissociate from each other at 70 degrees Celsius, while ionic bonds of sodium salts of ethylene-methacrylic acid copolymers dissociate from each other at 63 degrees Celsius.

Also, in this embodiment, the term “associate together in a cold state” means that, for example, hydrogen bonds of —OH groups of glucosamines dissociate from each other at 45 degrees Celsius, while ionic bonds of sodium salts of ethylene-methacrylic acid copolymers dissociate from each other at 40 degrees Celsius.

### Silane Crosslinking Groups

As compounds containing the silane crosslinking groups used in this embodiment, there can be listed, for example vinyltrimethoxysilanes and the like, but the compounds containing the silane crosslinking groups are not particularly limited thereto.

### Rubber Cable

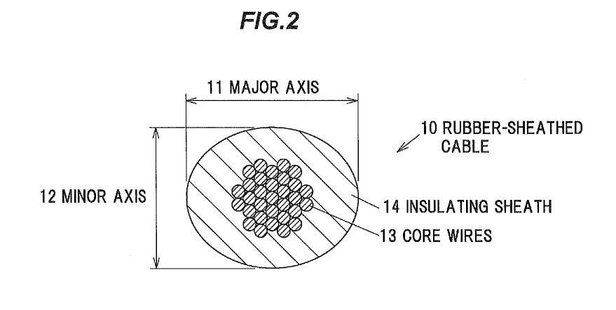

As shown in FIG. 2, a rubber-sheathed cable 10 in this embodiment uses the above described crosslinked rubber, and is configured so that an insulating sheath 14 formed using the above described crosslinked rubber is disposed around core wires 13. As shown in FIG. 2, the cross sectional shape of the rubber-sheathed cable 10 is flattened to have a major axis 11 and a minor axis 12 whose ellipticity defined later is preferably not less than 80%.

### Crosslinked Rubber Producing Method

The crosslinked rubber producing method in this embodiment includes: before crosslinking, introducing into rubber molecules silane crosslinking groups and hot dissociatable and cold associatable crosslinking groups to dissociate from each other in a hot state and associate together in a cold state; molding the rubber molecules with the hot dissociatable and cold associatable crosslinking groups and the silane crosslinking groups introduced therein; and silane-crosslinking the rubber molecules together by a silanol condensation reaction of the silane crosslinking groups together with moisture, with the hot dissociatable and cold associatable crosslinking groups associated together. Specifics are given in examples.

### EXAMPLES

The crosslinked rubber of the invention, the rubber-sheathed cable using the same, and the crosslinked rubber producing method are more specifically described below using examples. Incidentally, the examples below should not be construed to in any way limit the invention.

### Example 1

An example is given in which the crosslinked rubber of the invention having a molecular structure represented by Chemical formula 1 below is applied to an ethylene-propylene rubber (EP rubber).

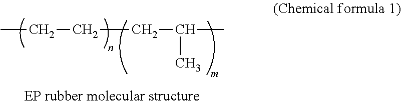

(1) Maleic Anhydride Grafting on the EP Rubber

As represented by Chemical formula 2 below, a mixture formulated below is kneaded with a 40 mm uniaxial kneader (number of revolutions 30 rpm) at 160 degrees Celsius, to graft a maleic anhydride on the EP rubber. This results in a maleic anhydride grafted EP rubber.

EP rubber (JSR Corporation: Product name: EP21); 100 parts by weight

Maleic anhydride (NOF Corporation: Product name: CRYSTAL MAN): 3 parts by weight

DCP (Kayaku Akzo Corporation): 0.1 parts by weight

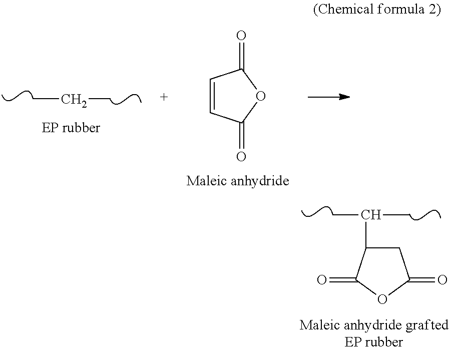

(2) Aminotriazole (ATA) Adding to the Maleic Acid Grafted EP Rubber

As represented by Chemical formula 3 below, in the maleic acid grafted EP rubber made in (1), an ATA is added and mixed as formulated below, and is kneaded with a kneader (number of revolutions 30 rpm) at 180 degrees Celsius for 30 minutes, resulting in an ATA added maleic acid grafted EP rubber having a structural formula below. The ATA added maleic acid group has many carboxyl groups and amino groups, and has many parts to form hydrogen bonds.

Maleic anhydride grafted EP rubber: 100 parts by weight

3-amino-1, 2, 4-triazole (ATA) (Nippon Carbide Industries Co., Ltd.): 2 parts by weight

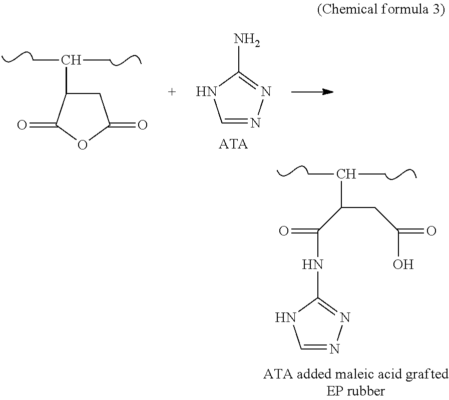

(3) Silane Crosslinking Group Grafting

As represented by Chemical Formula 4 below, a mixture formulated below is kneaded with a 40 mm uniaxial kneader (number of revolutions 30 rpm) at 160 degrees Celsius, to graft a silane crosslinking group. This results in a silane grafted ATA added maleic acid grafted EP rubber having a structure below.

ATA added maleic acid grafted EP rubber: 100 parts by weight

Vinyltrimethoxysilane (Shin-Etsu Chemical Co., Ltd.: Product name: KBM1003): 3 parts by weight

Des-γ-carboxy prothrombin (DCP): 0.1 parts by weight

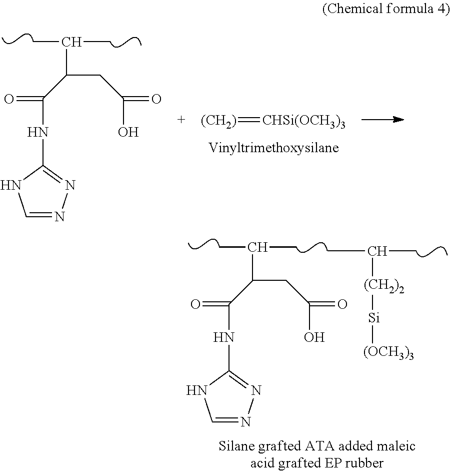

(4) Silanol Catalyst Added EP Rubber

A mixture formulated below is kneaded with a kneader (number of revolutions 30 rpm) at 150 degrees Celsius for 15 minutes, resulting in a catalyst masterbatch.

EP rubber (JSR Corporation: Product name: EP21): 100 parts by weight

Dibutyltin dilaurate: 1part by weight

(5) EP Rubber-Sheathed Cable Molding

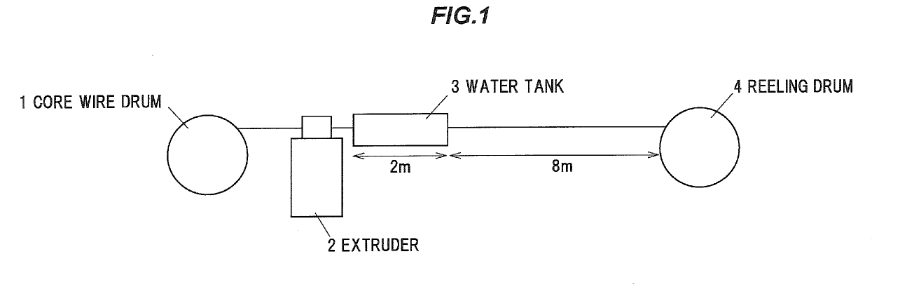

A mixture formulated below is extruded with a 40 mm uniaxial extruder (number of revolutions 5 rpm, 100 degrees Celsius), and is coated around a core wire. The configuration of the extrusion line is shown in FIG. 1.

Silane grafted ATA added maleic acid grafted EP rubber: 95 parts by weight Catalyst masterbatch: 5 parts by weight

As shown in FIG. 1, the production line speed is 2 m/min, and from a core wire drum 1, the core wire formed of a 0.75 mm² core wire size tin plated soft copper wire is coated with the 0.8 mm thick mixture by an extruder 2, and is passed through a water tank 3 (whose length is, for example 2 m), and is reeled around a reeling drum 4 (the distance from the water tank 3 to the reeling drum 4 is, for example 8 m). In this case, it is reeled around the reeling drum 4, with grafted ATA added maleic acid units hydrogen bonded together, as represented by Chemical formula 5 below.

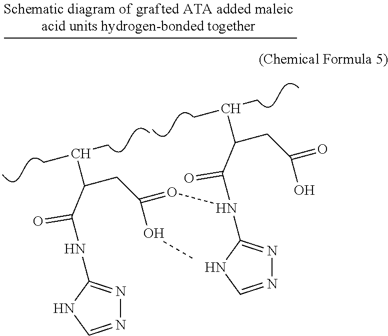

Subsequently, with the coated wire reeled around the reeling drum 4, the coated wire is left unattended at room temperature (23 degrees Celsius, humidity 50%) for 7 days, resulting in a silane crosslinking (silane crosslinked structure as represented by Chemical formula 6 below).

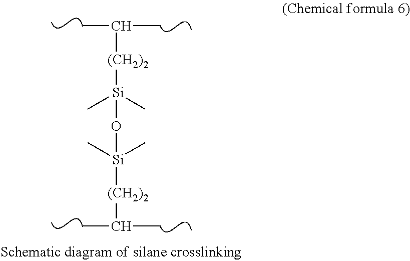

(6) Evaluation of Flattening

After the silane crosslinking, the cable is taken out from the reeling drum, and as shown in FIG. 2, a flattening of a cross sectional shape of the cable is evaluated. For the evaluation of flattening, its ellipticity defined below is calculated.

$$Ellipticity ( \% ) = \frac{Cross \text{-} sectional minor axis length}{Cross \text{-} sectional major axis length} \times 100$$

A desired value for the ellipticity is not less than 80%. The ellipticity of the cable in Example 1 was as good as 90%.

### Comparative Example 1

An example is given in which a crosslinked rubber is produced by grafting only the silane crosslinking group on the EP rubber.

(1) Silane Crosslinking Group Grafting

As represented by Chemical formula 7 below, a mixture formulated below is kneaded with a 40 mm uniaxial kneader (number of revolutions 30 rpm) at 160 degrees Celsius, to graft a silane crosslinking group. This results in a silane grafted EP rubber having a structure below.

EP rubber (JSR Corporation: Product name: EP21): 100 parts by weight

Vinyltrimethoxysilane (Shin-Etsu Chemical Co., Ltd.: Product name: KBM1003): 3 parts by weight

DCP: 0.1 parts by weight

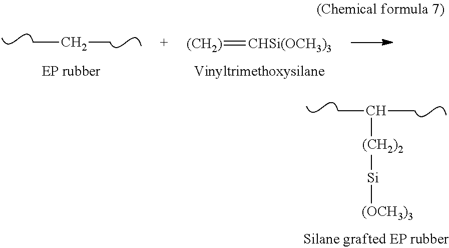

(2) Silanol Catalyst Added EP Rubber

A mixture formulated below is kneaded with a kneader (number of revolutions 30 rpm) at 150 degrees Celsius for 15 minutes, resulting in a catalyst masterbatch.

EP rubber (JSR Corporation: Product name: EP21): 100 parts by weight Dibutyltin dilaurate: 1 part by weight

(3) EP Rubber-Sheathed Cable Molding

A mixture formulated below is extruded with an extruder and in extrusion conditions similar to those of Example 1 into a shape similar to that of Example 1, and is coated around a core wire. Subsequently, with the coated wire reeled around the reeling drum 4, the coated wire is left unattended at room temperature (23 degrees Celsius, humidity 50%) for 7 days, resulting in a silane crosslinking.

Silane grafted EP rubber: 95 parts by weight

Catalyst masterbatch: 5 parts by weight

(4) Evaluation of Flattening

After the silane crosslinking, the cable is taken out from the reeling drum, and a flattening of a cross sectional shape of the cable is evaluated. For the evaluation of flattening, its ellipticity defined in Example 1 is calculated. The ellipticity of the cable in Comparative example 1 was 74%, which failed to achieve the desired value (not less than 80%).

### Example 2

An example is given in which the invention is applied to a chloroprene rubber (CR rubber) represented by Chemical formula 8.

(1) Glucosamine and Aminosilane Grafting on the CR Rubber

As represented by Chemical Formula 8 below, a mixture formulated below is kneaded with a 6 inch roll at 80 degrees Celsius for 5 minutes, resulting in a glucosamine and silane grafted CR rubber. The reaction formula is represented by Chemical formula 8 below, in which amino groups are added to 1, 2 linkage CR rubber.

CR rubber (Showa Denko KK: Product name: Chloroprene W): 100 parts by weight

Glucosamine: 1 part by weight

3-aminopropyltriethoxysilane: 2 parts by weight

Magnesium oxide: 3 parts by weight

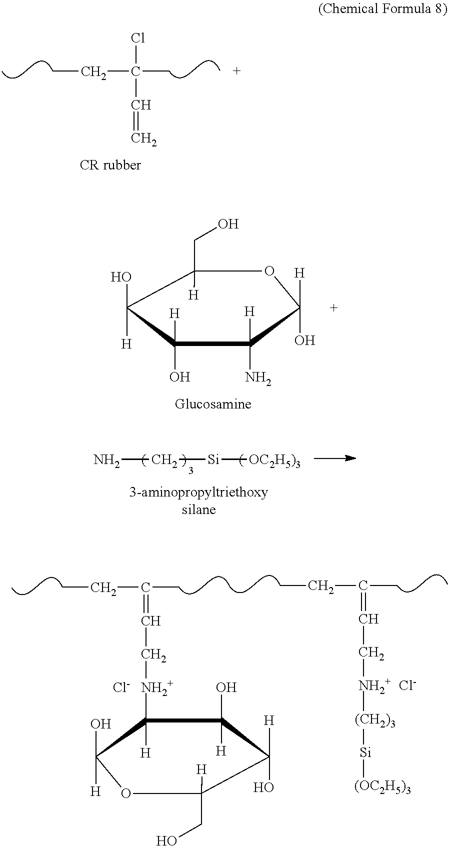

(4) Silanol Catalyst Added CR Rubber

A mixture formulated below is kneaded with a kneader (number of revolutions 30 rpm) at 80 degrees Celsius for 15 minutes, resulting in a catalyst masterbatch.

CR rubber (Showa Denko KK: Product name: Chloroprene W): 100 parts by weight

Dibutyltin dilaurate: 1 part by weight

Magnesium oxide: 3 parts by weight (5) CR Rubber-Sheathed Cable Molding

A mixture formulated below is extruded with a 40 mm uniaxial extruder (number of revolutions 5 rpm, 100 degrees Celsius), and is coated around a core wire. The configuration of the extrusion line is similar to the case of Example 1.

Glucosamine, silane grafted CR rubber: 95 parts by weight

Catalyst masterbatch: 5 parts by weight The production line speed is 2 m/min, and a 0.75 mm² core wire size tin plated soft copper wire is coated with the 0.8 mm thick mixture, and is reeled around a reeling drum. In this case, it is reeled around the reeling drum 4, with grafted glucosamine units hydrogen bonded together, as represented by Chemical formula 9 below.

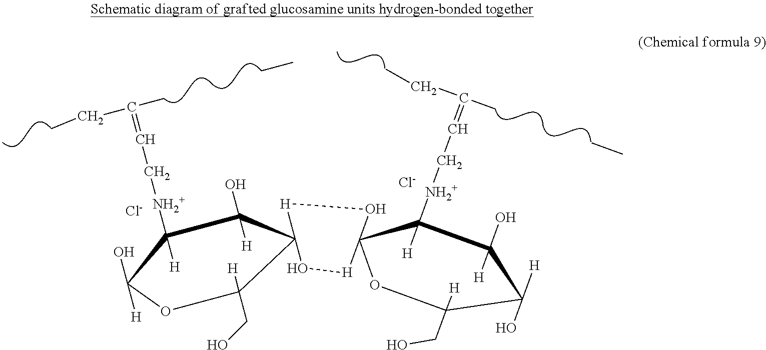

Subsequently, with the coated wire reeled around the reeling drum, the coated wire is left unattended at room temperature (23 degrees Celsius, humidity 50%) for 7 days, resulting in a silane crosslinking (silane crosslinked structure as represented by Chemical formula 10 below).

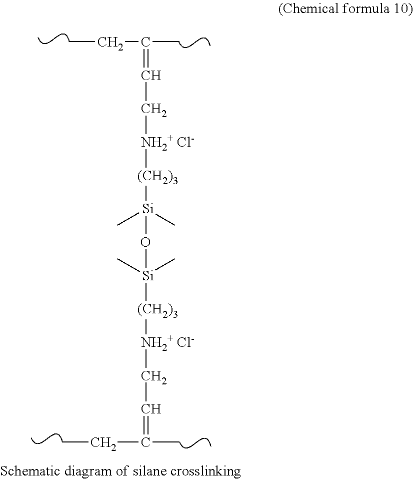

(6) Evaluation of Flattening

After the silane crosslinking, the cable is taken out from the reeling drum, and a flattening of a cross sectional shape of the cable is evaluated. For the evaluation of flattening, its ellipticity defined in Example 1 is calculated. The ellipticity of the cable in Example 2 was as good as 86%, which was the desired value of not less than 80%.

### Comparative Example 2

An example is given in which a crosslinked rubber is produced by grafting only the silane crosslinking group on the CR rubber.

(1) Silane Crosslinking Group Grafting

As represented by Chemical formula 11 below, a mixture formulated below is kneaded with a 6 inch roll at 80 degrees Celsius for 5 minutes, resulting in a silane grafted CR rubber. The reaction formula is represented by Chemical formula 11 below, in which amino groups are added to 1, 2 linkage CR rubber.

CR rubber (Showa Denko KK: Product name: Chloroprene W): 100 parts by weight

3-aminopropyltriethoxysilane: 2 parts by weight

Magnesium oxide: 3 parts by weight

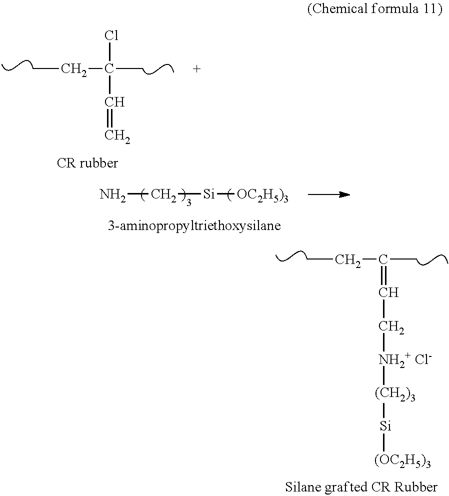

(2) Silanol Catalyst Added CR Rubber

A mixture formulated below is kneaded with a kneader (number of revolutions 30 rpm) at 80 degrees Celsius for 15 minutes, resulting in a catalyst masterbatch.

CR rubber (Showa Denko KK: Product name: Chloroprene W): 100 parts by weight

Dibutyltin dilaurate: 1 part by weight

Magnesium oxide: 3 parts by weight

(3) CR Rubber-Sheathed Cable Molding

A mixture formulated below is extruded with an extruder and in extrusion conditions similar to those of Example 2 into a shape similar to that of Example 2, and is coated around a core wire. Subsequently, with the coated wire reeled around the reeling drum, the coated wire is left unattended at room temperature (23 degrees Celsius, humidity 50%) for 7 days, resulting in a silane crosslinking.

Silane grafted CR rubber: 95 parts by weight

Catalyst masterbatch: 5 parts by weight

(4) Evaluation of Flattening

After the silane crosslinking, the cable is taken out from the reeling drum, and a flattening of a cross sectional shape of the cable is evaluated. For the evaluation of flattening, its ellipticity defined in Example 1 is calculated. The ellipticity of the cable in Comparative example 2 was 70%, which failed to achieve the desired value (not less than 80%).

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A crosslinked rubber, comprising
rubber molecules, which, before crosslinking, contain hot dissociatable and cold associatable crosslinking groups to dissociate from each other in a hot state and associate together in a cold state, and silane crosslinking groups, and which, after molding, are silane-crosslinked together by a silanol condensation reaction of the silane crosslinking groups together with moisture, with the hot dissociatable and cold associatable crosslinking groups associated together.

2. The crosslinked rubber according to claim 1, wherein
the hot dissociatable and cold associatable crosslinking groups are hydrogen bonding groups, ionic bonding groups, or dynamic covalent bonding groups.

3. A rubber-sheathed cable using the crosslinked rubber according to claim 1.

4. A crosslinked rubber producing method, comprising:
before crosslinking, introducing hot dissociatable and cold associatable crosslinking groups into rubber molecules, the hot dissociatable and cold associatable crosslinking groups being dissociated from each other in a hot state and associated together in a cold state;
introducing silane crosslinking groups into the rubber molecules with the hot dissociatable and cold associatable crosslinking groups introduced therein;
molding the rubber molecules with the hot dissociatable and cold associatable crosslinking groups and the silane crosslinking groups introduced therein; and
silane-crosslinking the rubber molecules together by a silanol condensation reaction of the silane crosslinking groups together with moisture, with the hot dissociatable and cold associatable crosslinking groups associated together.

5. The crosslinked rubber producing method according to claim 4, wherein
the hot dissociatable and cold associatable crosslinking groups are hydrogen bonding groups, ionic bonding groups, or dynamic covalent bonding groups.
